(19) United States
(12) Patent Application Publication
(10) Pub. No.: US 2021/0131333 A1
(43) Pub. Date: May 6, 2021

(54) EXHAUST VALVE

(71) Applicant: FAURECIA SYSTEMES D'ECHAPPEMENT, MANDEURE (FR)

(72) Inventors: Raphaël DE MATOS, SAONE (FR); Maxime ESNAULT, MANDEURE (FR)

(21) Appl. No.: 17/075,833

(22) Filed: Oct. 21, 2020

(30) Foreign Application Priority Data
Oct. 31, 2019 (FR) 19 12287

(51) Int. Cl. F01N 13/08

(52) U.S. Cl. CPC F01N 13/087

(57) ABSTRACT

An exhaust valve comprises a substantially tubular body, defining a passage section and extending along an extension axis, and a flap positioned in the tubular body across the passage section. The flap rotates about an axis of rotation, secant to the extension axis, between a closed orientation where the flap closes off the passage section and an open orientation where the flap frees the passage section. The tubular body comprises two flanges that are substantially symmetrical to one another and an annular sealing ring is positioned and maintained between the two flanges.

### CROSS-REFERENCE TO RELATED APPLICATIONS

This application is a U.S. non-provisional application claiming the benefit of French Application No. 19 12287, filed on Oct. 31, 2019, which is incorporated herein by reference in its entirety.

### TECHNICAL FIELD

The disclosure relates to the field of exhaust system valves, in particular for a motorized vehicle. An exhaust system valve is typically positioned in an exhaust line, downstream of an internal combustion engine. The exhaust system valve is conventionally used:

in relation with a tapping of said exhaust line to selectively withdraw at least part of the exhaust gases toward an exhaust gas recirculation (EGR),

in bypass, in order to orient all or part of the exhaust gases toward a heat recovery device, another circuit, or a sound attenuation device,

as device making it possible to generate a back-pressure, for acoustic purposes.

### BACKGROUND

It is known to produce an exhaust valve, comprising a body, extending along an extension axis, which is substantially tubular and defines a passage section centered on the extension axis. Said valve further comprises a substantially planar flap, positioned in the body across the passage section and having a section entirely fitted in the passage section. The flap rotates about an axis of rotation, secant to the extension axis, between a closed orientation where the flap is substantially perpendicular to the extension axis so as to close off the passage section and an open orientation where the flap is substantially parallel to the extension axis so as to free the passage section. According to one advantageous embodiment, the body comprises two parts that are substantially symmetrical to one another and positioned symmetrically relative to a plane perpendicular to the extension axis and passing through the axis of rotation.

Such a valve typically produces a flow noise, primarily when the flap is in the closed position, due to leaks present between the flap and the body. One way to reduce the flow noise is to reduce the leaks.

In light of a use in an exhaust line, such an exhaust valve is subject to high temperatures, on the order of 600° C. to 900° C. This prohibits the use of many conventional sealing solutions, such as solutions based on deformable elements, such as seals made from elastomeric materials.

A flap has a wing on each side of the axis of rotation. One sealing solution positions a substantially planar semi-annular lip on the inner wall of the body, opposite the periphery of each wing in the closed position. Thus, the substantially planar periphery of each wing bears, when the flap is in the closed position, against the substantially planar surface of the semi-annular lip facing it. A first semi-annular lip thus comes below the flap, while the other one comes above it. Such semi-annular lips can be made integral with the body, for example by molding or machining They can further be made independently, to next be attached, typically by welding, on the inner wall of the body. These methods used to produce these annular sealing lips require very precise positioning and/or machining and therefore incur additional costs.

### SUMMARY

The disclosure proposes an alternative solution, which is easy to implement, and has a low cost.

The disclosure produces two semi-annular lips using a single annular ring that is substantially symmetrical about the axis of rotation.

To this end, the disclosure relates to an exhaust valve, comprising a substantially tubular body, extending along an extension axis, and defining a passage section centered on the extension axis. A flap is positioned in the tubular body across the passage section and has a section entirely fitted in the passage section. The flap rotates about an axis of rotation, secant to the extension axis, between a closed orientation where the flap is substantially perpendicular to the extension axis so as to close off the passage section and an open orientation where the flap is not perpendicular to the extension axis so as to free the passage section The tubular body comprises two flanges that are substantially symmetrical to one another and that are positioned symmetrically relative to a plane perpendicular to the extension axis and passing through the axis of rotation. An annular sealing ring is positioned and maintained between the two flanges. Advantageously, the two flanges are made from metal.

Specific features or embodiments, which may be used alone or in combination, are:

the ring is substantially symmetrical around the axis of rotation,

the ring is planar and parallel to the plane,

the ring passes through the axis of rotation,

the ring comprises an opening having a section entirely fitted in the section of the flap,

a section of the flap perpendicular to the axis of rotation is S-shaped,

a section of the flap perpendicular to the axis of rotation is double S-shaped,

the flap comprises, on one side of the axis of rotation, a first substantially planar wing that is parallel to a face of the ring, and on another side of the axis of rotation, a second substantially planar wing that is parallel to another face of the ring. Advantageously, the ring is made from metal.

According to a second aspect, the disclosure relates to an exhaust line comprising at least one such exhaust valve.

According to a third aspect, the disclosure relates to a vehicle comprising at least one such exhaust line.

### BRIEF DESCRIPTION OF THE DRAWINGS

The disclosure will be better understood upon reading the following description, provided solely as an example, and in reference to the appended figures, in which:

FIG. 1 illustrates a perspective view of one embodiment of a valve according to the disclosure,

FIG. 2 illustrates, along the extension axis A, the valve of FIG. 1,

FIG. 3 illustrates, in exploded view, the valve of FIG. 1,

FIG. 4 illustrates, in cut view, along the axis of rotation B, the valve of FIG. 1, and

FIG. 5 illustrates, in cut view, along the axis of rotation B, another embodiment.

### DETAILED DESCRIPTION

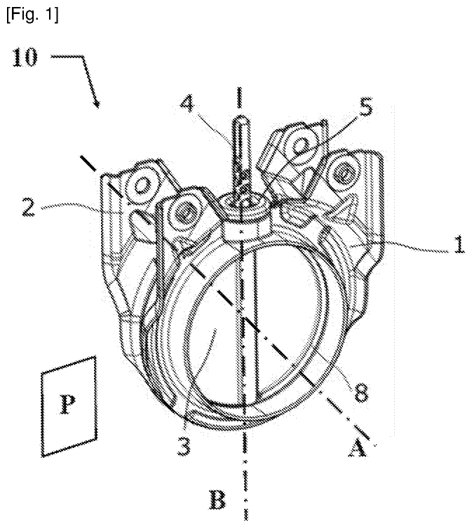

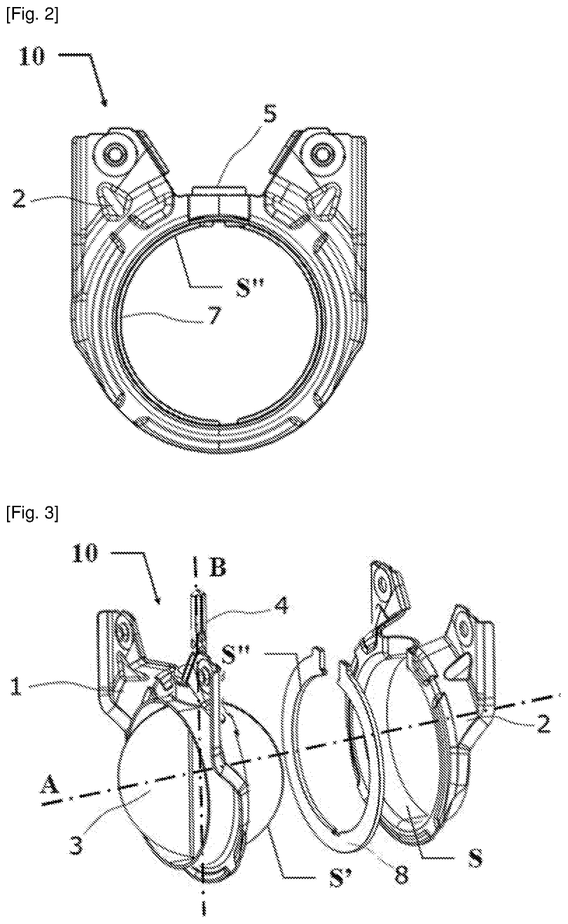

In reference to FIG. 1, an exhaust valve 10 comprises a substantially tubular body 1, 2, extending along an extension axis A, and defining a passage section S centered on the extension axis A. A flap 3 is positioned in the body 1, 2 across the passage section S. This flap 3 has a section S′. The flap 3, using a shaft 4, rotates about an axis of rotation B that is generally secant to the extension axis A. Said shaft 4 rotates using a bearing 5. Said flap 3 can thus go from a closed orientation where the flap 3 is substantially perpendicular to the extension axis A so as to close off the passage section S, as illustrated in FIG. 1, to an open orientation where the flap 3 is not perpendicular to the extension axis A, as illustrated in FIG. 3, for example while being substantially parallel to the extension axis A, so as to free the passage section S.

The section S′ of the flap 3 is entirely fitted in the passage section S of the body 1, 2 so as to be able to allow the rotation without interference with the body 1, 2. The section S′ is advantageously similar in shape to the passage section S, but smaller in size. The play between passage section S and section S′ is preferably reduced so as to facilitate the tightness in the closed position.

The body 1, 2 is advantageously made in two flanges or clamps that are substantially symmetrical to one another and arranged symmetrically relative to a plane P perpendicular to the extension axis A and passing through the axis of rotation B. According to one possible embodiment, the two flanges of the body 1, 2 are made by stamping and are assembled by welding.

According to one feature, the exhaust valve 10 further comprises an annular sealing ring 8. According to another feature, this ring 8 is substantially symmetrical around the axis of rotation B and is positioned and kept between the two flanges of the body 1, 2. According to another feature, it is welded between and/or with the flanges of the body 1, 2.

According to another feature, the ring 8 is planar and/or parallel to the plane P. This feature is advantageous in that it greatly simplifies the production of the ring 8. This feature is also advantageous in that it simplifies the assembly of the ring 8 between and with the two flanges of the body 1, 2. It is in fact easy to arrange a planar circular space corresponding to the section of the ring 8 by molding each of the two flanges accordingly. A precise positioning of the ring 8 and therefore of faces 6, 7 of the ring 8 is easy to obtain without any particular adjustment: the ring 8 naturally finds its place in a housing provided to that end between the two flanges.

The ring 8 has an outer section allowing it to be housed between the two flanges of the body 1, 2 and thus to ensure the sealing between bodies 1, 2 and ring 8. This outer section thus contains the entire passage section S.

The ring 8 also has an opening with section S″, advantageously centered on the extension axis A, and also advantageously of the same shape as the section S′ of the flap 3, and entirely fitted in the section S′ of the flap 3. Thus, when the flap 3, in the closed position, is superimposed with the ring 8, an overlap area is created that ensures the tightness between flap 3 and ring 8 and therefore between flap 3 and body 1, 2.

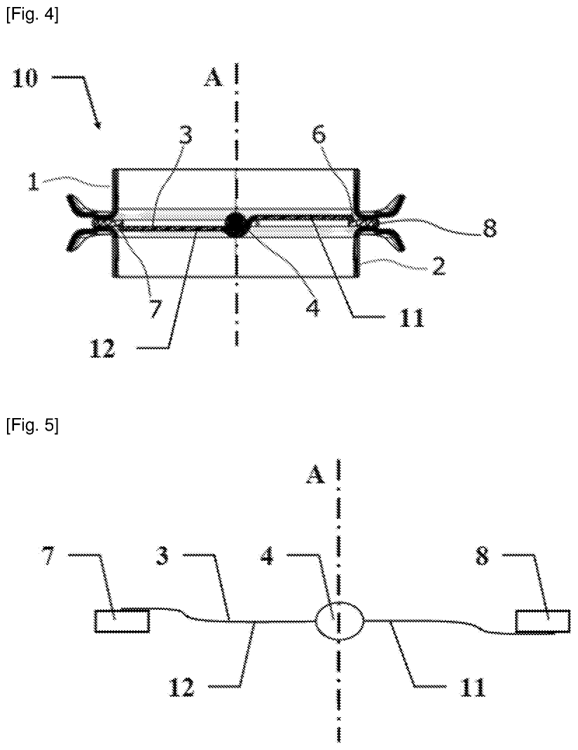

The ring 8 being planar, the shape of the flap 3 should be adapted to allow its rotation and planar docking between flap 3 and ring 8 in the closed position. To this end, as more particularly visible in FIG. 4, the flap 3 has an S-shaped section, along a plane perpendicular to the axis of rotation B.

The aim is for the flap 3, in the closed position, to be substantially parallel to the ring 8, at any point of its periphery, where it is superimposed with the ring 8.

According to another feature, more particularly visible in FIG. 4, the flap 3 comprises, on one side of the axis of rotation B, embodied by the shaft 4, a first substantially planar wing 11 and parallel to a face 6 of the ring 8. It can be noted that said first wing 11 docks with the face 6 from above. On the contrary, on the other side of the axis of rotation B, the flap 3 comprises a second wing 12 that is substantially planar and parallel to the face 7, opposite the face 6, of the ring 8. It can be noted that said second wing 12 docks with the face 7 from below. Therefore, the S shape ensures a shift between the two wings 11, 12 that allows each of the wings 11, 12 to be parallel respectively to one of the faces 6, 7 of the ring 8.

According to another embodiment, more particularly illustrated in FIG. 5, the flap 3 has a double S-shaped section along a plane perpendicular to the axis of rotation B. Such a shape is advantageous in that it makes it possible to produce a flap 3 centered on the axis of rotation B, while ensuring planar docking.

The disclosure further relates to an exhaust line comprising at least one such exhaust valve 10.

The disclosure also relates to a vehicle comprising at least one such exhaust line.

The disclosure has been illustrated and described in detail in the drawings and the preceding description. The latter must be considered to be illustrative and provided as an example, and not as limiting the disclosure to this description alone. Many variant embodiments are possible.

1. An exhaust valve, comprising:
a tubular body extending along an extension axis, defining a passage section centered on the extension axis;
a flap positioned in the tubular body across the passage section, the flap having a flap section entirely fitted in the passage section, rotating about an axis of rotation secant to the extension axis, between a closed orientation where the flap is perpendicular to the extension axis to close off the passage section and an open orientation where the flap is not perpendicular to the extension axis to free the passage section;
the tubular body comprising two flanges that are symmetrical to one another and that are positioned symmetrically relative to a plane perpendicular to the extension axis and passing through the axis of rotation; and
an annular sealing ring positioned and maintained between the two flanges.

2. The exhaust valve according to claim 1, where the annular sealing ring is symmetrical around the axis of rotation.

3. The exhaust valve according to claim 1, where the annular sealing ring is planar and parallel to the plane.

4. The exhaust valve according to claim 1, where the annular sealing ring passes through the axis of rotation.

5. The exhaust valve according to claim 1, where the annular sealing ring comprises an opening having an opening section entirely fitted in the flap section.

6. The exhaust valve according to claim 1, where a transverse section of the flap, perpendicular to the axis of rotation, is S-shaped.

7. The exhaust valve according to claim 1, where a transverse section of the flap perpendicular to the axis of rotation, is double S-shaped.

8. The exhaust valve according to claim 1, where the flap comprises, on one side of the axis of rotation, a first planar wing that is parallel to a face of the annular sealing ring, and on another side of the axis of rotation, a second planar wing that is parallel to another face of the annular sealing ring.

9. An exhaust line comprising at least one exhaust valve according to claim 1.

10. A vehicle comprising at least one exhaust line according to claim 9.
